(19) United States
(12) Patent Application Publication
(10) Pub. No.: US 2008/0280203 A1
(43) Pub. Date: Nov. 13, 2008

(54) Non-aqueous electrolyte secondary battery

(76) Inventors: Chihiro Yada, Osaka (JP); Hideki Kitao, Sakaiminato-shi (JP); Noriyuki Shimizu, Sakura-shi (JP); Yoshinori Kida, Osaka (JP)

Correspondence Address: KUBOVCIK & KUBOVCIK, SUITE 1105, 1215 SOUTH CLARK STREET, ARLINGTON, VA, 22202, US

(21) Appl. No.: 12/076,768

(22) Filed: Mar. 21, 2008

(30) Foreign Application Priority Data
Mar. 23, 2007 (JP) 2007-076212

(51) Int. Cl. H01M 4/00

(52) U.S. Cl. 429/220

(57) ABSTRACT

A non-aqueous electrolyte secondary battery has a positive electrode (11) containing a positive electrode active material capable of intercalating and deintercalating lithium ions; a negative electrode (12); and a non-aqueous electrolyte (14). The positive electrode active material contains Li_{b}FePO₄, where 0≦b<1, and a lithium-containing metal oxide represented by the general formula LiₓNi_{y}Mn_{z}MₐO₂, where M is at least one element selected from the group consisting of Na, K, B, F, Mg, Al, Ti, Co, Cr, V, Fe, Cu, Zn, Nb, Mo, Zr, Sn, and W, and where x, y, z, and a satisfy the following conditions 1<x<1.3, 0<y≦1, 0<z≦1, y<z, and 0≦a.

### BACKGROUND OF THE INVENTION

1. Field of the Invention

The present invention relates to a non-aqueous electrolyte secondary battery comprising a positive electrode capable of intercalating and deintercalating lithium ions, a negative electrode, and a non-aqueous electrolyte. More particularly, the invention relates to a non-aqueous electrolyte secondary battery that exhibits improvements in initial charge-discharge efficiency and charge-discharge capability, particularly an improvement in high rate capability, the battery employing a lithium-containing metal oxide containing at least nickel and manganese as a positive electrode active material in the positive electrode.

2. Description of Related Art

In recent years, non-aqueous electrolyte secondary batteries have been widely in use as a new type of high power, high energy density secondary battery. Non-aqueous electrolyte secondary batteries typically use a non-aqueous electrolyte and perform charge-discharge operations by transferring lithium ions between the positive electrode and the negative electrode.

In the non-aqueous electrolyte secondary batteries, a lithium-containing metal oxide containing a large amount of cobalt, such as lithium cobalt oxide LiCoO₂, is commonly used as the positive electrode active material in the positive electrode.

However, there have been some problems with this type of non-aqueous electrolyte secondary battery. For example, because the positive electrode active material contains scarce natural resources such as cobalt, the manufacturing cost is high and the supply tends to be unstable.

For these reasons, use of a lithium-containing nickel-manganese oxide containing at least nickel and manganese as a positive electrode active material that is inexpensive and enables stable supply has been investigated in recent years.

The lithium-containing nickel-manganese oxide, however, results in significantly poorer initial charge-discharge efficiency and high rate capability than conventional lithium cobalt oxide.

In view of the problem, pre-treating the lithium-containing nickel-manganese oxide with dilute nitric acid and ammonia has been proposed conventionally so that the initial charge-discharge efficiency can be improved (see, for example, Journal of Power Sources, Volume 153, 2006, pages 258-264).

Nevertheless, even with the use of the lithium-containing nickel-manganese oxide pre-treated with dilute nitric acid and ammonia as a positive electrode active material, sufficient improvements in high rate capability have not been achieved.

### BRIEF SUMMARY OF THE INVENTION

It is an object of the present invention to solve the foregoing and other problems in a non-aqueous electrolyte secondary battery comprising a positive electrode containing a positive electrode active material capable of intercalating and deintercalating lithium ions, a negative electrode, and a non-aqueous electrolyte, when using a lithium-containing metal oxide containing at least nickel and manganese as a positive electrode active material in the positive electrode.

In other words, it is an object of the present invention to improve the initial charge-discharge efficiency and the high rate capability of a non-aqueous electrolyte secondary battery that uses a lithium-containing metal oxide containing at least nickel and manganese as a positive electrode active material.

In order to accomplish the foregoing and other objects, the present invention provides a non-aqueous electrolyte secondary battery comprising: a positive electrode containing a positive electrode active material capable of intercalating and deintercalating lithium ions; a negative electrode; and a non-aqueous electrolyte, wherein the positive electrode active material contains Li_{b}FePO₄, where 0≦b<1, and a lithium-containing metal oxide represented by the general formula LiₓNi_{y}Mn_{z}MₐO₂, where M is at least one element selected from the group consisting of Na, K, B, F, Mg, Al, Ti, Co, Cr, V, Fe, Cu, Zn, Nb, Mo, Zr, Sn, and W, and where x, y, z and a satisfy the following conditions 1<x<1.3, 0<y≦1, 0<z≦1, y<z, and 0≦a.

When the lithium-containing metal oxide represented by the foregoing general formula LiₓNi_{y}Mn_{z}MₐO₂ is used, the oxidation-reduction reaction between Ni⁴⁺ and Ni²⁺ and the oxidation-reduction reaction between Mn⁴⁺ and Mn³⁺ take place as the charge-discharge reactions in the lithium-containing metal oxide because the mole ratio x of Li exceeds 1 and the mole ratio z of Mn is greater than the mole ratio y of Ni.

In addition, FePO₄ exists in the Li_{b}FePO₄ (where 0≦b<1). When Li_{b}FePO₄ (where 0≦b<1) is added to the positive electrode active material as described above, the oxidation-reduction reaction between Mn⁴⁺ and Mn³⁺ in the lithium-containing metal oxide represented by the foregoing general formula is activated by the catalysis of the FePO₄ in the Li_{b}FePO₄.

In the non-aqueous electrolyte secondary battery, if the amount of Li_{b}FePO₄ in the positive electrode active material is too large, the relative amount of the lithium-containing metal oxide represented by the above-described general formula becomes small, and the charge-discharge capacity of the positive electrode accordingly degrades. Therefore, it is preferable that the amount of Li_{b}FePO₄ in the positive electrode active material be 30 weight % or less.

Moreover, it is preferable that, in the initial charge, the non-aqueous electrolyte secondary battery be charged until the potential of the positive electrode reaches 4.45 V (Li/Li⁺) or higher, in order to activate the oxidation-reduction reaction between Mn⁴⁺ and Mn³⁺ in the lithium-containing metal oxide represented by the foregoing general formula and also to improve the charge-discharge capacity of the positive electrode in the non-aqueous electrolyte secondary battery.

As described above, in the non-aqueous electrolyte secondary battery according to the present invention, the positive electrode active material contains Li_{b}FePO₄, where 0≦b<1, and a lithium-containing metal oxide represented by the general formula LiₓNi_{y}Mn_{z}MₐO₂, where M is at least one element selected from the group consisting of Na, K, B, F, Mg, Al, Ti, Co, Cr, V, Fe, Cu, Zn, Nb, Mo, Zr, Sn, and W, and where x, y, z and a satisfy the following conditions 1<x<1.3, 0<y≦1, 0<z≦1, y<z, and 0≦a. Therefore, the oxidation-reduction reaction between Ni⁴⁺ and Ni²⁺ and the oxidation-reduction reaction between Mn⁴⁺ and Mn³⁺ take place as the charge-discharge reactions in the lithium-containing metal oxide. At the same time, the oxidation-reduction reaction between Mn⁴⁺ and Mn³⁺ is activated by the catalysis of the FePO₄ in the Li_{b}FePO₄.

As a result, the initial charge-discharge efficiency improves, and at the same time the high rate capability also improves in the non-aqueous electrolyte secondary battery according to the present invention.

### BRIEF DESCRIPTION OF THE DRAWINGS

FIG. 1 is a schematic illustrative drawing of a three-electrode test cell using as the working electrode a positive electrode fabricated according to Examples 1 and 2 of the present invention and Comparative Examples 1 through 16.

### DETAILED DESCRIPTION OF THE INVENTION

Hereinbelow, preferred embodiments of the non-aqueous electrolyte secondary battery according to the present invention are described in further detail.

As described above, the non-aqueous electrolyte secondary battery according to the present invention comprises a positive electrode containing a positive electrode active material capable of intercalating and deintercalating lithium ions, a negative electrode, and a non-aqueous electrolyte. The positive electrode active material contains Li_{b}FePO₄, where 0≦b<1, and a lithium-containing metal oxide represented by the general formula LiₓNi_{y}Mn_{z}MₐO₂, where M is at least one element selected from the group consisting of Na, K, B, F, Mg, Al, Ti, Co, Cr, V, Fe, Cu, Zn, Nb, Mo, Zr, Sn, and W, and where x, y, z and a satisfy the following conditions 1<x<1.3, 0<y≦1, 0<z≦1, y<z, and 0≦a.

Here, it is preferable that the mole ratio Mn/Ni (z/y) be 2 or greater, more preferably 3 or greater, in order to improve the charge-discharge capacity of the positive electrode by increasing the proportion of the oxidation-reduction reaction between Mn⁴⁺ and Mn³⁺ in the charge-discharge reactions, which consist of the oxidation-reduction reaction between Ni⁴⁺ and Ni²⁺ and the oxidation-reduction reaction between Mn⁴⁺ and Mn³⁺, in the lithium-containing metal oxide represented by the foregoing general formula used as a positive electrode active material.

Moreover, in order to make the oxidation-reduction reaction between Mn⁴⁺ and Mn³⁺ in the lithium-containing metal oxide more active, it is preferable that the amount of FePO₄ in the Li_{b}FePO₄ be greater. Therefore, it is preferable that b in the formula Li_{b}FePO₄ satisfy the condition 0≦b≦0.5, more preferably 0≦b<0.1. Furthermore, from the viewpoint of improving the energy density of the battery, it is preferable that the Li_{b}FePO₄ belongs to the space group Pnma.

The non-aqueous electrolyte secondary battery according to the present invention is characterized in that it employs the positive electrode active material as set forth above, so the rest of the parts of the battery may be configured like conventional non-aqueous electrolyte secondary batteries.

In the non-aqueous electrolyte secondary battery, the negative electrode active material used for the negative electrode may be any known commonly-used material. From the viewpoint of improving the energy density of the battery, it is desirable to use a material with a relatively low potential of the charge-discharge reaction, such as metallic lithium, a lithium alloy, and carbon materials such as graphite.

The non-aqueous electrolyte may be a commonly used non-aqueous electrolyte in which an electrolyte salt is dissolved in a non-aqueous solvent.

The non-aqueous solvent may be a commonly used solvent, and examples include cyclic carbonic esters, chain carbonic esters, esters, cyclic ethers, chain ethers, nitrites, amides, and combinations thereof.

Examples of the cyclic carbonic esters include ethylene carbonate, propylene carbonate and butylene carbonate. It is also possible to use a cyclic carbonic ester in which part or all of the hydrogen groups of the just-mentioned cyclic carbonic esters is/are fluorinated, such as trifluoropropylene carbonate and fluoroethyl carbonate.

Examples of the chain carbonic esters include dimethyl carbonate, diethyl carbonate, ethyl methyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is/are fluorinated.

Examples of the esters include methyl acetate, ethyl acetate, propyl acetate, methyl propionate, ethyl propionate, and γ-butyrolactone.

Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile, and examples of the amides include dimethylformamide.

Examples of the electrolyte salt to be dissolved in the non-aqueous solvent include LiPF₆, LiBF₄, LiCF₃SO₃, LiC₄F₉SO₃, LiN(CF₃SO₂)₂, LiN(C₂F₅SO₂)₂, LiAsF₆, LiN(CF₃SO₂)(C₄F₉SO₂), LiC(CF₃SO₂)₃, LiC(C₂F₅SO₂)₃, LiClO₄, Li₂B₁₀Cl₁₀, LiB(C₂O₄)₂, LiB(C₂O₄)F₂, LiP(C₂O₄)₃, LiP(C₂O₄)₂F₂, Li₂B₁₂Cl₁₂, and mixtures thereof.

From the viewpoint of improving the cycle performance of the battery, it is preferable to add a lithium salt having an oxalato complex as anions, more preferably lithium-bis(oxalato)borate, to the electrolyte salt.

### EXAMPLES

Hereinbelow, examples of the non-aqueous electrolyte secondary battery according to the present invention will be described in detail along with comparative examples, and it will be demonstrated that the examples of the non-aqueous electrolyte secondary battery according to the present invention achieve improved initial charge-discharge efficiency and improved high rate capability over the comparative examples of a non-aqueous electrolyte secondary battery. It should be construed, however, that the non-aqueous electrolyte secondary battery according to the present invention is not limited to the following examples, but various changes and modifications are possible without departing from the scope of the invention.

### Example 1

In Example 1, a positive electrode was prepared using Li_{1.22}Ni_{0.17}Mn_{0.61}O₂ as the lithium-containing metal oxide represented by the foregoing general formula, which was obtained by mixing Li₂CO₃ and a hydroxide of Ni_{0.17}Mn_{0.61} together and then sintering the mixture in air.

Li_{0.1}FePO₄ belonging to the space group Pnma, which was obtained by delithiation from LiFePO₄, was used as the Li_{b}FePO₄.

The just-described Li_{1.22}Ni_{0.17}Mn_{0.61}O₂ and Li_{0.1}FePO₄ were mixed together at a weight ratio of 85:15, and the resultant mixture was used as the positive electrode active material. The positive electrode active material, a carbon material as a conductive agent, and polyvinylidene fluoride as a binder agent were dissolved in a N-methyl-2-pyrrolidone solution so that the positive electrode active material, the conductive agent, and the binder agent were in a weight ratio of 90:5:5, and the resultant was kneaded to prepare a positive electrode mixture slurry. Then, the positive electrode mixture slurry was applied onto a current collector made of an aluminum foil and then dried. Thereafter, the resultant material was pressure-rolled using pressure rollers and thereafter cut into a predetermined size. Thus, a positive electrode was prepared.

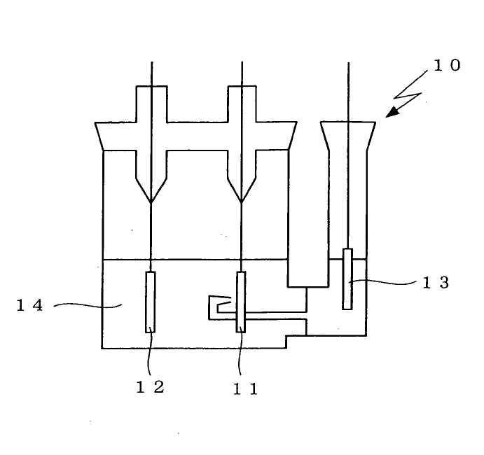

Then, a three-electrode test cell 10 as illustrated in FIG. 1 was prepared using the following components. The positive electrode prepared in the above-described manner was used as the working electrode 11. Metallic lithium was used for the counter electrode 12 and for the reference electrode 13. Lithium hexafluorophosphate (LiPF₆) was dissolved at a concentration of 1 mol/L into a mixed solvent of ethylene carbonate, ethyl methyl carbonate, and dimethyl carbonate in a volume ratio of 4:3:3, to prepare the non-aqueous electrolyte solution 14.

### Example 2

In Example 2, a positive electrode was prepared in the same manner described as in Example 1 above, except that the positive electrode active material used was a mixture of the Li_{1.22}Ni_{0.17}Mn_{0.61}O₂ and the Li_{0.1}FePO₄ in a weight ratio of 70:30. Using the prepared positive electrode, a three-electrode test cell was prepared in the same manner as described in Example 1 above.

### Comparative Example 1

In Comparative Example 1, a positive electrode was prepared in the same manner as described in Example 1 above, except that the positive electrode active material used was Li_{1.22}Ni_{0.17}Mn_{0.61}O₂ alone. Using the prepared positive electrode, a three-electrode test cell was prepared in the same manner as described in Example 1 above.

### Comparative Example 2

In Comparative Example 2, a positive electrode was prepared in the same manner as described in Example 1 above, except that the positive electrode active material used was a mixture of Li_{1.22}Ni_{0.17}Mn_{0.61}O₂ and LiFePO₄ in a weight ratio of 85:15. In the LiFePO₄, b in the formula Li_{b}FePO₄ is 1, so the LiFePO₄ does not satisfy the requirements of the present invention. Using the prepared positive electrode, a three-electrode test cell was prepared in the same manner as described in Example 1 above.

### Comparative Example 3

In Comparative Example 3, a positive electrode was prepared in the same manner as described in Example 1 above, except that the positive electrode active material used was LiNi_{0.40}Co_{0.30}Mn_{0.30}O₂ alone. Although the LiNi_{0.40}Co_{0.30}Mn_{0.30}O₂ contains Ni and Mn, it does not meet the requirements of the lithium-containing metal oxide represented by the foregoing general formula since the mole ratio x of Li is 1 and the mole ratio z of Mn is smaller than the mole ratio y of Ni. Using the prepared positive electrode, a three-electrode test cell was prepared in the same manner as described in Example 1 above.

### Comparative Example 4

In Comparative Example 4, a positive electrode was prepared in the same manner described as in Example 1 above, except that the positive electrode active material used was a mixture of the same LiNi_{0.40}Co_{0.30}Mn_{0.30}O₂ as used in Comparative Example 3 above and the Li_{0.1}FePO₄ in a weight ratio of 85:15. Using the prepared positive electrode, a three-electrode test cell was prepared in the same manner as described in Example 1 above.

### Comparative Example 5

In Comparative Example 5, a positive electrode was prepared in the same manner as described in Example 1 above, except that the positive electrode active material used was Li_{1.08}Ni_{0.46}Mn_{0.46}O₂ alone. Although the Li_{1.08}Ni_{0.46}Mn_{0.46}O₂ contains Ni and Mn, it does not meet the requirements of the lithium-containing metal oxide represented by the foregoing general formula since the mole ratio z of Mn and the mole ratio y of Ni are equal. Using the prepared positive electrode, a three-electrode test cell was prepared in the same manner as described in Example 1 above.

### Comparative Example 6

In Comparative Example 6, a positive electrode was prepared in the same manner described as in Example 1 above, except that the positive electrode active material used was a mixture of the same LiNi_{1.08}Co_{0.46}Mn_{0.46}O₂ as used in Comparative Example 5 above and the Li_{0.1}FePO₄ in a weight ratio of 95:5. Using the prepared positive electrode, a three-electrode test cell was prepared in the same manner as described in Example 1 above.

### Comparative Example 7

In Comparative Example 7, a positive electrode was prepared in the same manner described as in Example 1 above, except that the positive electrode active material used was a mixture of the same LiNi_{1.08}Co_{0.46}Mn_{0.46}O₂ as used in Comparative Example 5 above and the Li_{0.1}FePO₄ in a weight ratio of 90:10. Using the prepared positive electrode, a three-electrode test cell was prepared in the same manner as described in Example 1 above.

Next, each of the three-electrode test cells of Examples 1, 2 and Comparative Examples 1 through 7, prepared in the above-described manners, was charged at a constant current of 0.8 mA/cm² to an end-of-charge voltage of 4.6 V (vs. Li/Li⁺), and further charged at a constant voltage of 4.6 V (vs. Li/Li⁺) until the current value reached 0.08 mA/cm², whereby the initial charge capacity Qc for each three-electrode test cell was determined.

Then, each three-electrode test cell was rested for 10 minutes and thereafter discharged at a constant current of 0.08 mA/cm² to an end-of-discharge voltage of 2.0 V (vs. Li/Li⁺), whereby the initial discharge capacity Qd for each three-electrode test cell was determined.

The initial charge-discharge efficiency (%) was determined for each of the three-electrode test cells of Examples 1, 2 and Comparative Examples 1 through 7, from the initial charge capacity Qc and the initial discharge capacity Qd according to the following equation. The results are shown in Table 1 below.

Initial charge−discharge efficiency(%)=(Qd/Qc)×100

Next, each of the three-electrode test cells of Examples 1, 2 and Comparative Examples 1 through 7, which were subjected to the initial charge-discharge in the above-described manner, was charged at a constant current of 0.75 mA/cm² to 4.3 V (vs. Li/Li⁺) and then rested for 10 minutes. Thereafter, each cell was charged at a constant current of 0.25 mA/cm² to 4.3 V (vs. Li/Li⁺) and then discharged at a constant current of 9.0 mA/cm² to an end-of-discharge voltage of 2.5 V (vs. Li/Li⁺), whereby the high-rate discharge capacity (mAh/g) per 1 g of positive electrode active material during high-rate discharge was determined for each three-electrode test cell.

In addition, each of the three-electrode test cells of Examples 1, 2 and Comparative Examples 1 through 7 was discharged at a constant current of 0.75 mA/cm² to 2.5 V (vs. Li/Li⁺) and thereafter charged at a constant current of 9.0 mA/cm² to an end-of-charge voltage of 4.3 V (vs. Li/Li⁺), whereby the high-rate charge capacity (mAh/g) per 1 g of positive electrode active material during high-rate charge was determined for each three-electrode test cell.

TABLE 1

| | | Initial | High- | |
|---|---|---|---|---|
| | | charge- | rate | High-rate |
| | | discharge | charge | discharge |
| | Positive electrode active | efficiency | capacity | capacity |
| | material/weight ratio | (%) | (mAh/g) | (mAh/g) |
| Ex. 1 | Li_{1.22}Ni_{0.17}Mn_{0.61}O₂: | 76.9 | 61.1 | 75.0 |
| | Li_{0.1}FePO₄ = 85:15 | | | |
| Ex. 2 | Li_{1.22}Ni_{0.17}Mn_{0.61}O₂: | 90.2 | 64.5 | 78.1 |
| | Li_{0.1}FePO₄ = 70:30 | | | |
| Comp. | Li_{1.22}Ni_{0.17}Mn_{0.61}O₂ | 72.4 | 54.6 | 70.9 |
| Ex. 1 | | | | |
| Comp. | Li_{1.22}Ni_{0.17}Mn_{0.61}O₂: | 72.1 | 68.6 | 74.5 |
| Ex. 2 | LiFePO₄ = 85:15 | | | |
| Comp. | LiNi_{0.40}Co_{0.30}Mn_{0.30}O₂ | 89.3 | 105.0 | 107.3 |
| Ex. 3 | | | | |
| Comp. | LiNi_{0.40}Co_{0.30}Mn_{0.30}O₂: | 121.9 | 16.2 | 51.7 |
| Ex. 4 | Li_{0.1}FePO₄ = 70:30 | | | |
| Comp. | Li_{1.08}Ni_{0.46}Mn_{0.46}O₂ | 87.5 | 2.1 | 26.0 |
| Ex. 5 | | | | |
| Comp. | Li_{1.08}Ni_{0.46}Mn_{0.46}O₂: | 88.6 | 0.1 | 9.6 |
| Ex. 6 | Li_{0.1}FePO₄ = 95:5 | | | |
| Comp. | Li_{1.08}Ni_{0.46}Mn_{0.46}O₂: | 94.7 | 0.1 | 10.0 |
| Ex. 7 | Li_{0.1}FePO₄ = 90:10 | | | |

As evident from the results, improvements in the initial charge-discharge efficiency as well as improvements in the high-rate charge capacity and the high-rate discharge capacity were achieved by the cells of Examples 1 and 2, which contain as a positive electrode active material Li_{1.22}Ni_{0.17}Mn_{0.61}O₂, which meets the requirements of the lithium-containing metal oxide represented by the foregoing general formula, and Li_{0.1}FePO₄, in which b in the formula Li_{b}FePO₄ is less than 1, over the cell of Comparative Example 1, which contained no Li_{0.1}FePO₄, and the cell of Comparative Example 2, which contained LiFePO₄, in which b in the formula Li_{b}FePO₄ is 1.

In contrast, the cell of Comparative Example 2, using LiFePO₄ in which b in the formula Li_{b}FePO₄ is 1, showed a poorer initial charge-discharge efficiency than that of Comparative Example 1, although it yielded better high-rate charge/discharge capacities. Thus, unlike the present invention, the cell of Comparative Example 2 did not provide the advantageous effect of improving the initial charge-discharge efficiency.

In addition, in the cells of Comparative Examples 3, 4 and 5 through 7, each of which used a lithium-containing metal oxide containing Ni and Mn but not meeting the requirements of the lithium-containing metal oxide represented by the foregoing general formula, the high-rate charge capacity and the high-rate discharge capacity were rather decreased by the addition of the Li_{0.1}FePO₄, in which b in the formula Li_{b}FePO₄ is less than 1. Thus, the cells of Comparative Examples 3, 4 and 5 through 7 did not provide the advantageous effect of the present invention, in which the high-rate charge capacity and the high-rate discharge capacity are improved by the addition of Li_{0.1}FePO₄, in which b in the formula Li_{b}FePO₄ is less than 1.

### Comparative Example 8

In Comparative Example 8, a positive electrode was prepared in the same manner as described in Example 1 above, except that the positive electrode active material used was LiNi_{0.80}Co_{0.15}Al_{0.05}O₂ alone, which is a lithium-containing metal oxide that does not contain Mn. Using the prepared positive electrode, a three-electrode test cell was prepared in the same manner as described in Example 1 above.

### Comparative Example 9

In Comparative Example 9, a positive electrode was prepared in the same manner described as in Example 1 above, except that the positive electrode active material used was a mixture of the same LiNi_{0.80}Co_{0.15}Al_{0.05}O₂ as used in Comparative Example 8 above and the Li_{0.1}FePO₄ in a weight ratio of 95:5. Using the prepared positive electrode, a three-electrode test cell was prepared in the same manner as described in Example 1 above.

### Comparative Example 10

In Comparative Example 10, a positive electrode was prepared in the same manner described as in Example 1 above, except that the positive electrode active material used was a mixture of the same LiNi_{0.80}Co_{0.15}Al_{0.05}O₂ as used in Comparative Example 8 above and the Li_{0.1}FePO₄ in a weight ratio of 90:10. Using the prepared positive electrode, a three-electrode test cell was prepared in the same manner as described in Example 1 above.

### Comparative Example 11

In Comparative Example 11, a positive electrode was prepared in the same manner as described in Example 1 above, except that the positive electrode active material used was LiCoO₂ alone, which is a lithium-containing metal oxide that contains no Ni or Mn. Using the prepared positive electrode, a three-electrode test cell was prepared in the same manner as described in Example 1 above.

### Comparative Example 12

In Comparative Example 12, a positive electrode was prepared in the same manner described as in Example 1 above, except that the positive electrode active material used was a mixture of the same LiCoO₂ as used in Comparative Example 11 above and the Li_{0.1}FePO₄ in a weight ratio of 70:30. Using the prepared positive electrode, a three-electrode test cell was prepared in the same manner as described in Example 1 above.

### Comparative Example 13

In Comparative Example 13, a positive electrode was prepared in the same manner as described in Example 1 above, except that the positive electrode active material used was Li_{1.1}Mn_{1.9}O₄ alone, which is a lithium-containing metal oxide that does not contain Ni. Using the prepared positive electrode, a three-electrode test cell was prepared in the same manner as described in Example 1 above.

### Comparative Example 14

In Comparative Example 14, a positive electrode was prepared in the same manner described as in Example 1 above, except that the positive electrode active material used was a mixture of the same Li_{1.1}Mn_{1.9}O₄ as used in Comparative Example 13 above and the Li_{0.1}FePO₄ in a weight ratio of 70:30. Using the prepared positive electrode, a three-electrode test cell was prepared in the same manner as described in Example 1 above.

### Comparative Example 15

In Comparative Example 15, a positive electrode was prepared in the same manner as described in Example 1 above, except that the positive electrode active material used was LiFePO₄ alone, which is a lithium-containing metal oxide that contains no Ni or Mn. Using the prepared positive electrode, a three-electrode test cell was prepared in the same manner as described in Example 1 above.

### Comparative Example 16

In Comparative Example 16, a positive electrode was prepared in the same manner described as in Example 1 above, except that the positive electrode active material used was a mixture of the same LiFePO₄ as used in Comparative Example 15 above and the Li_{0.1}FePO₄ in a weight ratio of 70:30. Using the prepared positive electrode, a three-electrode test cell was prepared in the same manner as described in Example 1 above.

Using the three-electrode test cells of Comparative Examples 8 through 17 prepared in the above-described manners, the initial charge-discharge efficiency (%) for each cell was determined in the foregoing manner. Likewise, the high-rate discharge capacity (mAh/g) per 1 g of positive electrode active material during high-rate discharge and the high-rate charge capacity (mAh/g) per 1 g of positive electrode active material during high-rate charge were also determined for each cell in the foregoing manner.

TABLE 2

| | | Initial | High- | |
|---|---|---|---|---|
| | | charge- | rate | High-rate |
| | | discharge | charge | discharge |
| | Positive electrode active | efficiency | capacity | capacity |
| | material/weight ratio | (%) | (mAh/g) | (mAh/g) |
| Comp. | LiNi_{0.80}Co_{0.15}Al_{0.05}O₂ | 92.3 | 130.4 | 148.9 |
| Ex. 8 | | | | |
| Comp. | LiNi_{0.80}Co_{0.15}Al_{0.05}O₂: | 98.4 | 121.7 | 139.7 |
| Ex. 9 | Li_{0.1}FePO₄ = 95:5 | | | |
| Comp. | LiNi_{0.80}Co_{0.15}Al_{0.05}O₂: | 102.9 | 113.4 | 126.8 |
| Ex. 10 | Li_{0.1}FePO₄ = 90:10 | | | |
| Comp. | LiCoO₂ | 95.1 | 115.6 | 128.1 |
| Ex. 11 | | | | |
| Comp. | LiCoO₂:Li_{0.1}FePO₄ = 70:30 | 128.3 | 4.0 | 81.7 |
| Ex. 12 | | | | |
| Comp. | Li_{1.1}Mn_{1.9}O₄ | 92.1 | 100.3 | 111.5 |
| Ex. 13 | | | | |
| Comp. | Li_{1.1}Mn_{1.9}O₄:Li_{0.1}FePO₄ = | 246.0 | 44.4 | 80.2 |
| Ex. 14 | 70:30 | | | |
| Comp. | LiFePO₄ | 95.3 | 58.6 | 62.3 |
| Ex. 15 | | | | |
| Comp. | LiFePO₄:Li_{0.1}FePO₄ = | 137.3 | 54.3 | 61.5 |
| Ex. 16 | 70:30 | | | |

The results demonstrate the following. In the cells of Comparative Examples 8 through 17, each of which used a lithium-containing metal oxide not containing at least one of Ni or Mn as a positive electrode active material, the addition of the Li_{0.1}FePO₄ resulted in rather poorer high-rate charge capacity and poorer high-rate discharge capacity, as in the cells of Comparative Examples 3, 4 and 5 through 7, each of which used a lithium-containing metal oxide containing Ni and Mn but not meeting the requirements of the lithium-containing metal oxide represented by the foregoing general formula. Thus, the cells of Comparative Examples 8 through 17 did not provide the advantageous effect of the present invention, in which the high-rate charge capacity and the high-rate discharge capacity are improved by the addition of Li_{0.1}FePO₄, in which b in the formula Li_{bFePO4} is less than 1.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

This application claims priority of Japanese patent application No. 2007-076212 filed Mar. 23, 2007, which is incorporated herein by reference.

What is claimed is:

1. A non-aqueous electrolyte secondary battery comprising: a positive electrode comprising a positive electrode active material capable of intercalating and deintercalating lithium ions; a negative electrode; and a non-aqueous electrolyte; wherein the positive electrode active material contains Li_{b}FePO₄, where 0°b<1, and a lithium-containing metal oxide represented by the general formula LiₓNi_{y}Mn_{z}MₐO₂, where M is at least one element selected from the group consisting of Na, K, B, F, Mg, Al, Ti, Co, Cr, V, Fe, Cu, Zn, Nb, Mo, Zr, Sn, and W, and where x, y, z, and a satisfy the following conditions 1<x<1.3, 0<y≦1, 0<z≦1, y<z, and 0≦a.

2. The non-aqueous electrolyte secondary battery according to claim 1, wherein the amount of the Li_{b}FePO₄ in the positive electrode active material is 30 weight % or less.

3. The non-aqueous electrolyte secondary battery according to claim 1, wherein the battery is charged until the potential of the positive electrode reaches 4.45 V (Li/Li⁺) or higher in initial charge.

4. The non-aqueous electrolyte secondary battery according to claim 2, wherein the battery is charged until the potential of the positive electrode reaches 4.45 V (Li/Li⁺) or higher in initial charge.
